(19) United States
(12) Patent Application Publication
(10) Pub. No.: US 2016/0273688 A1
(43) Pub. Date: Sep. 22, 2016

(54) Quick Connector for Hydraulic Hose Coupling

(71) Applicant: Caterpillar Inc., Peoria, IL (US)

(72) Inventors: Patrick E. Considine, JR., Aurora, IL (US); Carl H. Rempert, Shorewood, IL (US)

(73) Assignee: Caterpillar Inc., Peoria, IL (US)

(21) Appl. No.: 14/658,909

(22) Filed: Mar. 16, 2015

(51) Int. Cl. F16L 21/03; F16L 37/14; F16L 21/08

(52) U.S. Cl. CPC F16L 21/03; F16L 21/08; F16L 37/14

(57) ABSTRACT

A hydraulic fluid line coupling system is disclosed. The coupling may include a female fitting, a male fitting, first and second elastomeric seals between the female fitting and male fitting, and a spring clip securing the male fitting against the female fitting.

### TECHNICAL FIELD

The present disclosure generally relates to hydraulic systems and, more particularly, relates to couplings for hydraulic hoses and tubes of hydraulics systems.

### BACKGROUND

Hydraulics are used in numerous applications. For example, with earth moving, construction, and agricultural equipment, various implements and attachments are powered by hydraulic cylinders. Using a track-type tractor as an example, the blade, bucket or other implement on the front of the loader are attached to boom arms swingably attached to the chassis of the track-type tractor. Movement of the boom arms and implements are powered by hydraulic cylinders. The hydraulic cylinders are in turn in fluid communication with a hydraulic fluid pump powered by an engine mounted on the chassis. Accordingly, it can be seen that multiple couplings are needed when communicating the hydraulic fluid from the pump to the cylinders.

While effective, and used for decades, the couplings between the various tubes and hoses of the hydraulic system are particularly prone to leakage. Such leakage necessarily detrimentally affects the efficiency of the machine, adds cost to operation of the machine, and disturbs the environment.

In light of the foregoing, it has been known to provide robust couplings between the hydraulic conduits of such hydraulic systems. Such robust couplings typically include a plurality of threaded bolts connecting fittings attached to the adjacent hydraulic hoses. The inclusion of multiple bolts, typically four, thus makes it a fairly time consuming process to connect and disconnect conduits. In addition, current couplings are rotationally sensitive in that the mating halves of the coupling must be symmetrically aligned before the bolts can be attached. This also adds to the time involved with changing conduits. Moreover, leakage from such robust connectors continues to be problematic.

With respect to patented technology, U.S. Pat. No. 7,490,388 discloses a clamp for connecting a duct to a base surface which includes a hinged clamp assembly sized so as to circumscribe the ducts being joining. A threaded bolt removably connects the two halves of the clamp together. However, such a device does not provide any sealing capability whatsoever.

Accordingly, it can be seen that a need exists for a hydraulic fluid line coupling system with improved resistance to leakage, reduced reliance on rotational orientation of the coupling components, quick assembly and disassembly, and which is designed for reduced likelihood of accidental pressure discharge.

### SUMMARY

In accordance with one aspect of the disclosure, hydraulic fluid line coupling system is disclosed which may comprise a female fitting, a male fitting, and a spring clip securing the male fitting against the female fitting.

In accordance for another aspect of the disclosure, a method of sealing a hydraulic fluid line coupling system is disclosed which may comprise inserting a male fitting into a female fitting, sealing the male fitting to the female fitting using first and second elastomeric rings, and securing the male fitting to the female fitting using a spring clip.

In accordance with yet another aspect of the disclosure, a machine is disclosed which may comprise a chassis, engine mounted on the chassis, a hydraulic fluid pump powered by the engine, a hydraulic cylinder in fluid the communication with the hydraulic fluid pump, a plurality of a hydraulic fluid tubes connecting the hydraulic fluid pump and the hydraulic cylinder and a, hydraulic fluid line coupling system connecting the plurality of the hydraulic fluid tubes together, each hydraulic fluid line coupling system including a male fitting, a female fitting, a first and second elastomeric seals between the male and female fittings, and a spring clip securing the male fitting to the female fitting.

These are other aspects and features of the present disclosure will be more readily understood when read in light of the following detailed description when taken in conjunction with the accompany drawings.

### BRIEF DESCRIPTION OF THE DRAWINGS

FIG. 1 is a perspective view of a machine constructed in accordance with the teachings of the present disclosure;

FIG. 2 is a schematic illustration of a hydraulic system constructed in accordance with the teachings of the present disclosure;

FIG. 3 is a perspective view of a hydraulic fluid line coupling system constructed in accordance with the teachings of the disclosure;

FIG. 4 is a cross-sectional view of the hydraulic fluid line coupling system of FIG. 3, with hydraulic fluid conduits attached;

FIG. 5 is an exploded view of the hydraulic fluid line coupling system of FIG. 3;

FIG. 6 is a flow chart depicting a sample sequence of steps which may be practiced in accordance with the teachings of the present disclosure.

While the present disclosure is susceptible to various modifications and alternative construction, certain illustrative embodiments that are shown and described below in detail. However, it is to be understood that the present disclosure is not limited to the specific embodiments disclosed, but instead includes all modifications, alternatives, constructions, and equivalents thereof.

### DETAILED DESCRIPTION

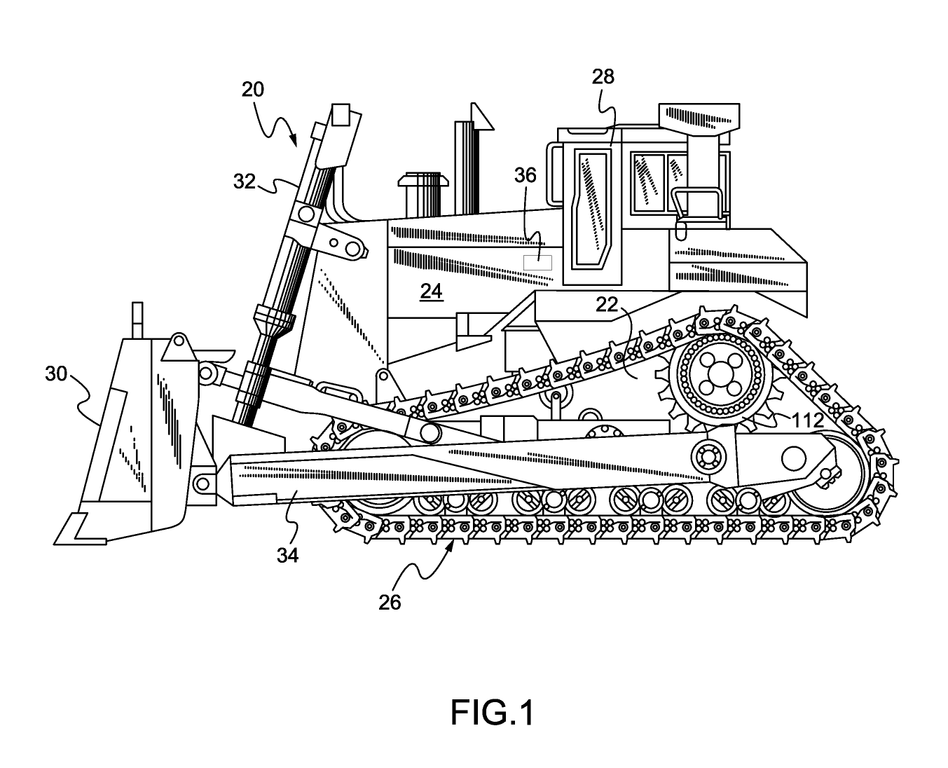

Referring now to drawings, and with specific reference to FIG. 1, a machine constructed in accordance to the teachings of the present disclosure is generally referred to by reference numeral 20. While the machine 20 is depicted as a track-type tractor, it is to be understood that the teachings of the present disclosure can be used with equal efficacy in connection with any other number of earth-moving machines including but not limited to loaders, motor graders, pipe layers, skid steers and the like. In addition, the teachings of the present disclosure can be used outside of earth-moving equipment including, but not limited to, other construction, agricultural, mining, marine, and on-highway machines.

With respect to the machine 20, it is shown to include a chassis 22 on which is mounted an engine 24. The machine 20 further includes first and second tracks 26 laterally flanking the machine, although in other embodiments, the form of locomotion may be provided in alternative formats such as, but not limited to, wheels. In addition, the chassis 22 supports an operator cabin 28.

As also illustrated in FIG. 1, the machine 20 may include one more more implements 30 provided to perform useful work. The implement 30 depicted in FIG. 1 is a blade, but other implements are certainly possible and well known. The implement 30 is movable relative to the machine 20 by way of one or more hydraulic cylinders 32 and boom arms 34. The hydraulic cylinders 32 are in fluid communication with a hydraulic fluid pump 36 by way of a plurality of hydraulic fluid conduits 38. The pump 36 in turn is powered by the engine 24.

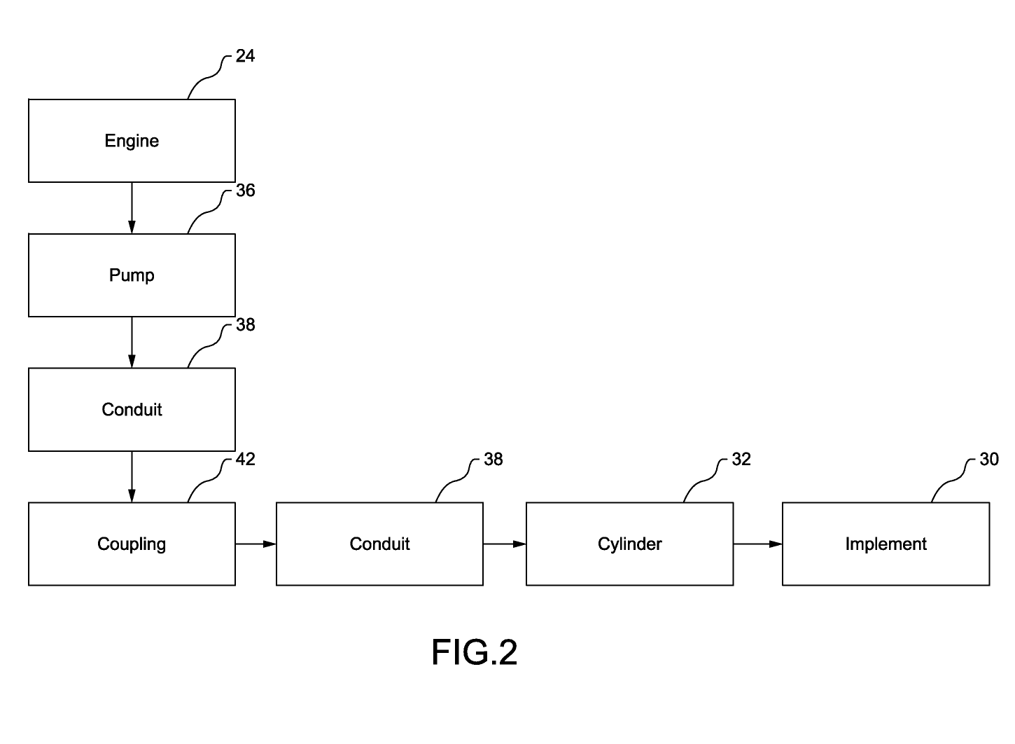

Turning now to FIG. 2, a schematic illustration of a hydraulic fluid system 40 constructed in accordance with the teachings of the present disclosure is provided. As shown therein, the hydraulic fluid system 40 includes the afore-mentioned pump 36 in fluid communication with the hydraulic cylinders 32 by way of conduits 38. In addition, FIG. 2 further illustrates that the plurality of hydraulic fluid conduits 38 are connected by way of hydraulic fluid line coupling systems 42 as will now be described in further detail.

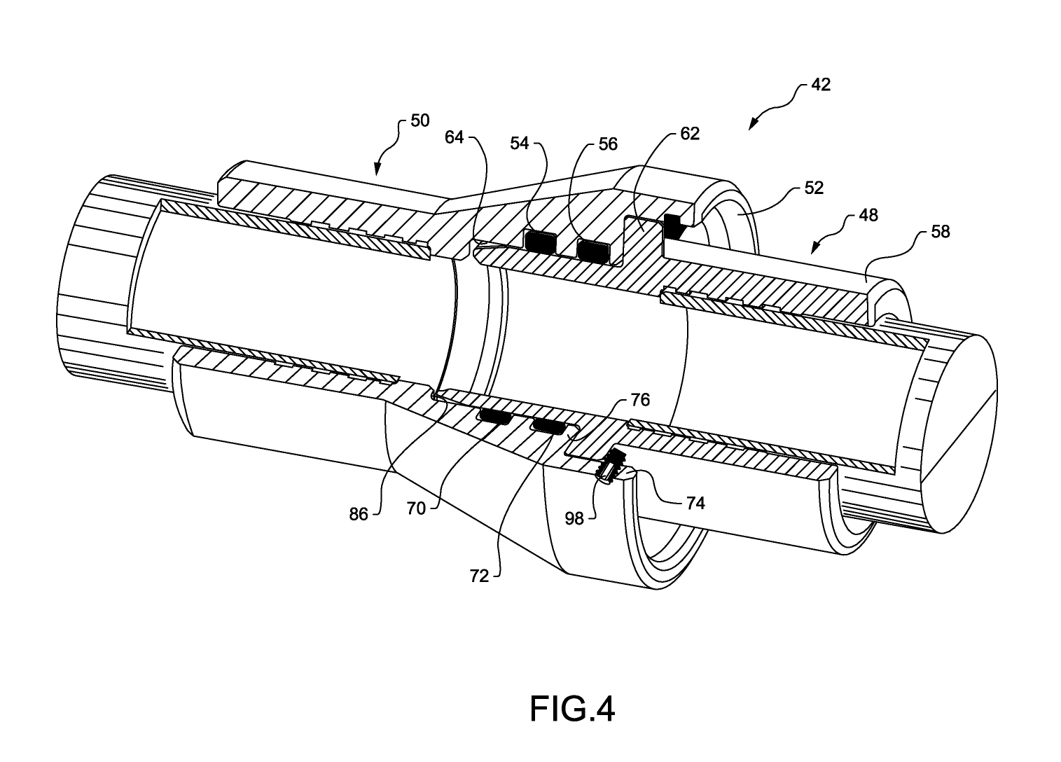

The hydraulic fluid line coupling system 42 is shown, in FIG. 4, connecting a first hydraulic fluid tube or hose 44 to a second hydraulic fluid tube 46. While hydraulic fluid tube couplings have been known in the prior art, the present disclosure drastically improves on such attempts by having improved sealing capability, no reliance on rotational orientation of the tubes, quicker assembly and disassembly, lower costs to manufacture, and improved resistance to accidental pressure discharge.

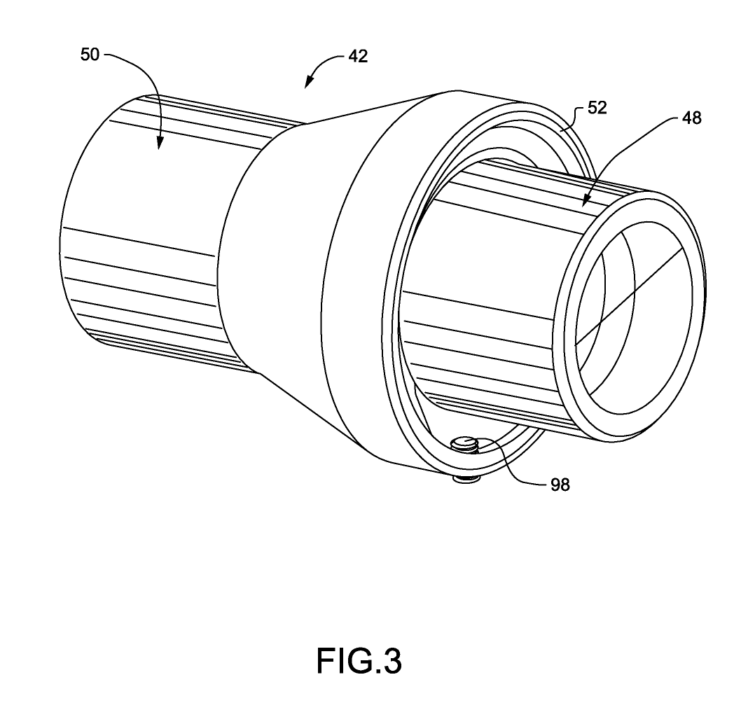

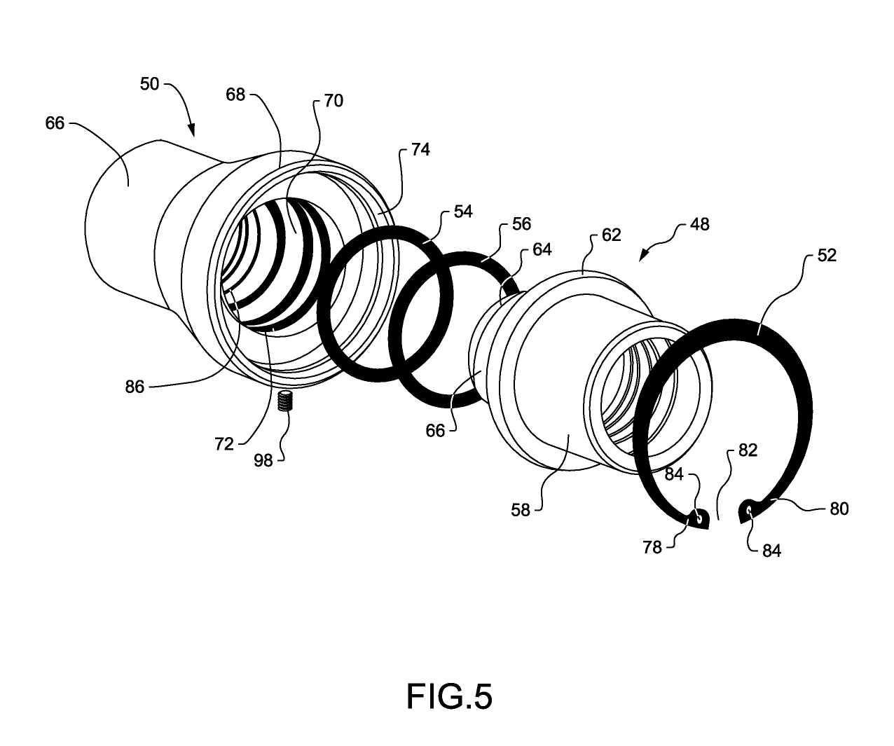

As shown in FIGS. 3-5, the hydraulic fluid line coupling system 42 includes a male fitting 48, a female fitting 50, a spring clip 52, a first elastomeric radial seal 54 and a second elastomeric radial seal 56. With specific reference to FIG. 5, the male fitting 48 is shown in detail to be substantially cylindrical in shape including a hose or proximal end 58 and a sealing or distal end 60. Intermediate the proximal and distal ends 58 and 60 the male fitting 48 is shown to also include a radially outwardly extending rib 62. In addition, the distal end 60 is shown to include a tapered rim 64, the importance of which will be described in further detail herein. Although the depicted male fitting 48 is substantially cylindrical in shape, it is to be understood that in other embodiments other geometric shapes are possible, such as but not limited to those which in cross-section are triangular, square, hexagonal, or other polygonal shapes.

With respect to the female fitting 50, it is also shown in detail in FIG. 5. The female fitting 58 also includes a proximal or hose end 66 and a distal or sealing end 68. The proximal end 66 may be substantially cylindrical in shape as is the distal end 68, while a bridge 69 therebetween may be substantially conical in shape. First, second, and third internally circumferential or radial grooves 70, 72, 74, as well an internal shoulder 76, may be provided on an interior surface 77 of the female fitting 50.

With respect to the spring clip 52, it is shown best in FIG. 5 to be accurate in shape with first and second ends 78 and 80. The spring clip 52 does not extend a full 360° of rotation, but rather terminates there before with a gap 82 between the ends 78 and 80. The spring clip 52 is manufactured from a memory metal so as to be biased into a circular configuration. In order to remove the spring clip 52, a user squeezes the ends 78 and 80 together, thereby reducing the diameter of the spring clip 52. When inserting, as will be described in further detail herein, the ends 78 and 80 are released, thereby allowing the spring clip 52 to re-expand into the third groove 74 of the female fitting 50. The ends 78 and 80 may be provided with apertures 84 or the like to facilitate grasping as by pliers or a specially tool.

Finally, also depicted in FIG. 5 are the first elastomeric seal 54 and the second elastomeric 56. Whereas the male fitting 48, female fitting 50 and spring clip 52 are manufactured from rigid materials such as, but not limited to, steel and other metals, the elastomeric seals 54 and 56 are manufacture from flexible materials such as, but not limited to, rubber and polymeric O-rings, gaskets, or the like. While the hydraulic fluid line coupling system 42 is shown having first and second radial seals 54 and 56, it is to be understood that in other embodiments, more than two seals, or less than two seals, could be used.

When assembled, the hydraulic fluid line coupling system 42 joins the first tube 44 and second tube 46, as shown best in FIG. 4, in a fluid tight arrangement with redundant seals for robustness against leaks, no reliance on rotational orientation of the various components for assembly, quick assembly, and greatly improved ability to prevent accidental pressure discharges. These features are perhaps best illustrated in the sectional view of FIG. 4. As will be noted therein, the redundant sealing feature is provided by way of the first elastomeric seal 54 and second elastomeric seal 56. As shown therein, the first elastomeric radial seal 54 is sized so as to be inserted within the first internal radial groove 70 of the female fitting 50. When the female fitting 50 is received around the male fitting 48, the first elastomeric seal 54 is compressed within the first circumferential groove 70 so as to prevent any fluid transmission therebetween. To improve longevity of the radial seal 54, a back-up ring (not shown) could be used. The back-up ring could be annular in shape and reside within the radial groove 70 to support the radial seal 54 so as to not extrude due to hydraulic pressure. In some embodiments more than one back-up ring could be used which each radial seal so as to flank the radial seal and provide support from both sides.

In addition, the second elastomeric radial seal 56 is received within the second internal radial groove 72 such that when the male fitting 48 is thoroughly received within the female fitting 50, the second elastomeric radial seal 56 is compressed therein as well. So as to facilitate fluid tight engagement between the male and female fittings 48 and 50, it will be noted that the tapered rim 68 is provided so as to draw the male fitting fully against a stop 86 of the female fitting 50 when the hydraulic fluid line coupling system 42 is assembled. A back-up ring or rings could be associated with the second radial seal 56 as well.

While the first and second elastomeric seal 54 and 56 provide the redundant sealing capabilities guarding against leaks, the improved ability of the hydraulic fluid line coupling system 42 against accidental pressure discharge is provided in part by way of the spring clip 52. As shown best in FIG. 4, the spring clip 52 is received within the third internal circumferential or radial groove 74. In such a position, the spring clip 52 engages the rib 62 of the male fitting 48 against the shoulder 76 of the female fitting 50. In doing so, the male fitting 48 is locked within the female fitting 50 and cannot be accidentally disconnected. Accidental pressure discharge is therefore avoided. This accidental pressure discharge avoidance is further enhanced by providing a set screw 98. As will be noted best in FIG. 4, the set screw 98 may penetrate the female fitting 50, as by threads or the like, proximate the gap 82 in the spring clip 52. The set screw penetrates the female fitting 50 to a depth sufficient to engage the rib 62 of the male fitting and prevent inadvertent removal of same.

Not only does the hydraulic fluid line coupling system 42 of the present disclosure provide for improved sealing and accidental pressure discharge prevention, but as will be noted, all of the components described above are not reliant on any particular rotational orientation so as to be effective. This is in marked contrast to prior art couplings which required the connecting components of the coupling to be rotated in a particular orientation before being connected. In so doing, the speed with which the coupling 42 can be assembled and disassembled is greatly improved.

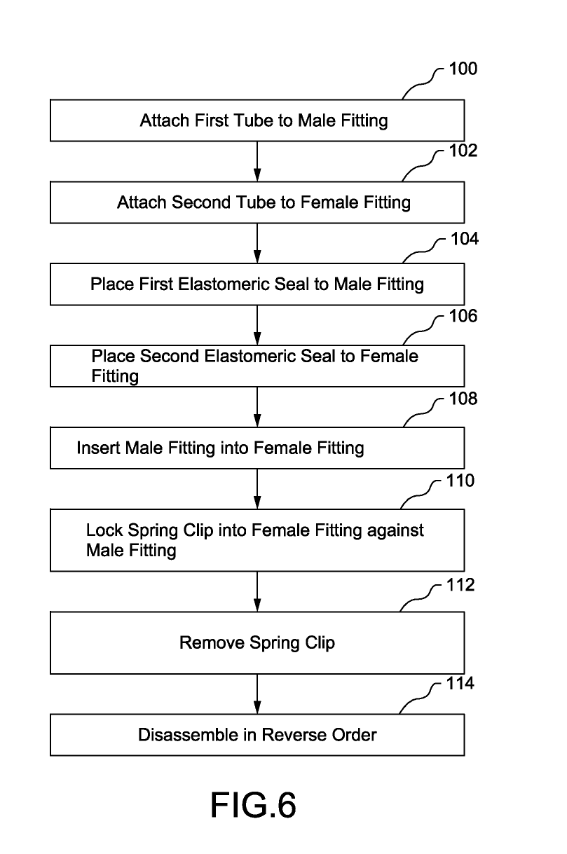

Referring now to FIG. 6, a flow chart depicting the sample sequence of steps which may be practiced in conjunction with the teachings of the present disclosure is provided. Stated differently, the present disclosure does not only set forth structure enabling improved sealing capability and hydraulic fluid line coupling system, but also a method of improved sealing and hydraulic fluid line coupling system as well.

Starting with a step 100, the method includes attaching the male fitting 48 to the first tube 44. This may be done as by crimping, welding, blazing or the like. Similarly, in a second step 102, the female fitting 50 is attached to the second tube 46. Once the male and female fittings 48 and 50 are attached to the tubes 44 and 46, the first and second elastomeric seals 54 and 56 are placed within the female fitting 50 as indicated in steps 104 and 106. In a next step 108, the male fitting 48 is then inserted into the female fitting 50 until rib 62 engages shoulder 76 with the first and second elastomeric seals 54 and 56 being compressed there between. In order to secure the tubes 44 and 46 together, the spring clip 52 is then locked into the third internal circumferential groove 74 of the female fitting 50 as indicated in a step 110.

While the foregoing sets forth a method steps for connecting the first and the second tubes 44 and 46, it is to be understood that the method of the present disclosure also includes a method for quickly disassembling the hydraulic fluid line coupling system 42 as well. In so doing, in a step 112, the hydraulic fluid line coupling system 42 is disassembled simply by removing the spring clip 52 and conducting the steps 100 through 110 in reverse order, as noted in step 116.

### INDUSTRIAL APPLICABILITY

In operation, the present disclosure can find industrial applicability, in a number of different settings. For example, in the construction of earth moving machines, multiple hydraulic fluid tubes are routed in and around the machine. As each of those tubes needs to be interconnected, the present disclosure sets forth a coupling for doing so in a reliable sealed manner without any reliance upon the rotational orientation of the components. In addition, it does so quickly, at a minimal of cost, and with greatly improved ability to prevent accidental pressure discharge.

With respect to improved sealing capability, such is set forth by providing redundant seals in the form of first and second elastomeric seals between the male and female fitting of the coupling. In so doing, if one seal were to degrade or even fail, the second seal will be able to continue to provide leakage prevention.

With respect to avoiding rotational orientation reliance, it can be seen that each of the components of the coupling are provided in symmetric fashion such that regardless of the rotational orientation of the components the coupling can be assembled and disassembled with ease.

With respect to speed of assembly and disassembly, as opposed to prior art devices which both require a specific rotation orientation to be operable, and multiple fasteners for providing the seal, the present disclosure provides a single spring clip which simply needs to be squeezed for the coupling to be disassembled.

Finally, with regard to prevention of accidental pressure discharge, as the assembly is connected by way of a spring clip biased outwardly and locked into a receiving groove of the female fitting by a set screw, the likelihood of the coupling coming apart and causing accidental pressure discharge is greatly reduced.

What is claimed is:

1. A hydraulic fluid line coupling system, comprising:
a female fitting;
a male fitting received within the female fitting; and
a spring clip securing the male fitting against the female fitting.

2. The hydraulic fluid line coupling system of claim 1, further including first and second elastomeric radial seals circumscribing the male fitting.

3. The hydraulic fluid line coupling system of claim 1, wherein the female fitting includes externally cylindrical proximal and distal ends, and an externally conical bridge therebetween.

4. The hydraulic fluid line coupling system of claim 3, wherein the conical bridge includes first and second internal radial grooves receiving first and second elastomeric radial seals.

5. The hydraulic fluid line coupling system of claim 4, wherein the cylindrical distal end includes a third internal radial groove receiving the spring clip.

6. The hydraulic fluid line coupling system of claim 5, wherein the male fitting includes a cylindrical proximal end and a cylindrical distal end, the cylindrical distal end being of a smaller diameter than the cylindrical proximal end.

7. The hydraulic fluid line coupling system of claim 6, wherein the male fitting further includes a radially outwardly extending rib between the cylindrical distal end and the cylindrical proximal end.

8. The hydraulic fluid line coupling system of claim 7, wherein the female fitting distal end further includes a radially inwardly directed shoulder, the radially outwardly directed rib of the male fitting engaging the radially inwardly directed shoulder.

9. The hydraulic fluid line coupling system of claim 8, wherein the spring clip engages the male fitting rib against the female fitting shoulder.

10. A method of sealing a hydraulic fluid line coupling system, comprising;
inserting a male fitting into a female fitting;
sealing the male fitting to the female fitting using first and second elastomeric rings; and
securing the male fitting to the female fitting using a spring clip.

11. The method of claim 10, further including positioning the first and second elastomeric rings circumferentially around the male fitting;

12. The method of claim 11, further including receiving the first and second elastomeric rings into first and second circumferential internal grooves provided in the female fitting.

13. The method of claim 12, further including receiving the spring clip in a third circumferential internal groove provided in the female fitting.

14. The method of claim 13, further including disassembling the hydraulic fluid line coupling system by squeezing the spring clip.

15. The method of claim 13, further including engaging a radially outwardly extending rib of the male fitting with a radially inwardly directed shoulder of the female fitting.

16. A machine, comprising;
a chassis;
an engine mounted on the chassis;
a hydraulic fluid pump powered by the engine;
a hydraulic cylinder in fluid communication with the hydraulic fluid pump;
a plurality of hydraulic fluid tubes connecting the hydraulic fluid pump and the hydraulic cylinder; and
a hydraulic fluid line coupling system connecting the plurality of hydraulic fluid tubes together, each hydraulic fluid line coupling system including a male fitting, a female fitting, first and second elastomeric seals between the male and female fittings, and a spring clip securing the male fitting against the female fitting.

17. The machine of claim 16, wherein the first and second elastomeric seals circumscribe the male fitting.

18. The machine of claim 17, wherein the female coupling includes first and second internal radial grooves receiving the first and second elastomeric seals.

19. The machine of claim 18, wherein the female coupling further includes a third internal radial groove receiving the spring clip.

20. The machine of claim 18, wherein the female coupling further includes a radially inwardly directed circumferential shoulder, and the male fitting further includes a radially outwardly directed circumferential rib, the spring clip forcing the shoulder and rib to engage each other.
